(19) United States
(12) Patent Application Publication
(10) Pub. No.: US 2003/0170108 A1
(43) Pub. Date: Sep. 11, 2003

(54) Tricycle forklift

(76) Inventor: J. Robert Hummer, Lititz, PA (US)

Correspondence Address: VOLPE AND KOENIG, P.C., UNITED PLAZA, SUITE 1600, 30 SOUTH 17TH STREET, PHILADELPHIA, PA, 19103, US

(21) Appl. No.: 10/346,952

(22) Filed: Jan. 17, 2003

Related U.S. Application Data
(60) Provisional application No. 60/349,888, filed on Jan. 17, 2002.

(51) Int. Cl. B66F 9/16

(52) U.S. Cl. 414/662

(57) ABSTRACT

A high flotation forklift with six degrees of freedom for movement of the fork assembly is provided. All of the movements to the fork assembly can be done while the forklift itself remains stationary. In addition to the conventional up-down movement, side-side movement, and front-back tilt, the present forklift provides for forward and backward fork movement, left-right yaw and side-to-side tilting while the forklift itself remains stationary. This allows for exact placement of any item, and is especially suited for placement of turf trays.

### CROSS-REFERENCE TO RELATED APPLICATIONS

The present application claims the benefit of U.S. Provisional Application No. 60/349,888, filed Jan. 17, 2002, which is incorporated herein by reference as if fully set forth.

### BACKGROUND

The present invention relates to a forklift that allows precise placement of items, and in particular to a forklift for use in connection with placing grass tiles used in forming athletic surfaces and which has low ground pressure and high flotation so that it does not damage a grass surface that it traverses

It is known to grow turf for use in athletic fields in modular trays, and then to assemble a playing field surface by abutting and/or connecting adjacent trays together. This can be done with turf in the trays, but it is also possible to install the turf removed from the trays. Regardless of the system used for installing the turf, the turf is grown and transported in the trays at a site away from the actual end use athletic field. In one application which was developed by the present inventor, the trays are approximately seven feet square, and the turf is grown in a tray, and then either removed from the tray for installation on a playing surface or installed with the tray in abutting relation to adjacent trays to form a playing surface.

During handling of the turf in trays, such as in a growing area, it is advantageous to have all of the trays directly abutting one another for ease of maintenance, mowing and care of the turf. However, exact placement of the trays using conventional forklifts was difficult to achieve. For playing fields constructed of turf in trays, exact placement of the trays becomes even more critical so that there are no gaps in the playing surface. In smaller systems, where the trays are approximately three feet square, the trays can be manually pushed and pried into position. However, for field turf systems utilizing larger turf tiles in trays, such as seven foot square turf tiles in trays, this is not possible.

Therefore, there is a need for a more versatile piece of equipment for moving and placing turf trays in exact positions.

### SUMMARY

The present invention provides a high flotation forklift with six degrees of freedom for movement of the forks while the forklift itself remains stationary. In addition to the conventional up-down movement, side-side movement, and front-back tilt, the forklift in accordance with the present invention provides for forward and backward fork movement, left-right yaw and side-side tilting all while the forklift itself remains stationary. This allows for exact placement of any item, and is especially suited for placement of turf trays.

In addition, the forklift in accordance with the present invention utilizes high flotation, low ground pressure tires which are suitable for use on turf without causing damage to the turf.

### BRIEF DESCRIPTION OF THE DRAWINGS

The foregoing summary as well as the following detailed description will be readily understood in conjunction with the appended drawings which illustrate the preferred embodiments of the invention. In the drawings:

FIG. 1 is a perspective view of a tricycle forklift in accordance with the present invention.

FIG. 2 is a perspective view of a turf field being assembled with turf located in trays utilizing the tricycle forklift in accordance with the present invention.

FIG. 3 is a perspective view of the front frame and mast assembly of the forklift in accordance with the present invention.

FIG. 4 is an enlarged view of the center portion of FIG. 3 showing the mast assembly connection to the frame.

FIG. 5 is a side elevational view of a tricycle forklift in accordance with a second preferred embodiment of the invention.

FIG. 6 is a side view, partially in cross-section of the tricycle forklift of FIG. 5 illustrating the moveable center beam used for the mast support and the associated actuators.

FIG. 7 is a top plan view of the forklift of FIG. 6 illustrating the moveable center beam and mast arrangement.

FIG. 8 is a cross-sectional view taken along line 8-8 in FIG. 7.

FIG. 9 is an enlarged isometric view illustrating the moveable center beam and mast support arrangement.

FIG. 10 is a cross-section taken along line 10-10 in FIG. 9.

FIG. 11 is a perspective view of the three joy stick control for the fork assembly of the forklift of FIG. 5.

FIG. 12 is an enlarged view of the control diagram for the three-joy stick control.

### DETAILED DESCRIPTION OF THE PREFERRED EMBODIMENTS

Certain terminology is used in the following description for convenience only and is not considered limiting. The words “right,” “left,” “lower” and “upper” designate directions in the drawings to which reference is made. This terminology includes the words specifically noted above, derivatives thereof and words of similar import. Additionally, the terms “a” and “one” are defined as including one or more of the referenced items unless specifically noted.

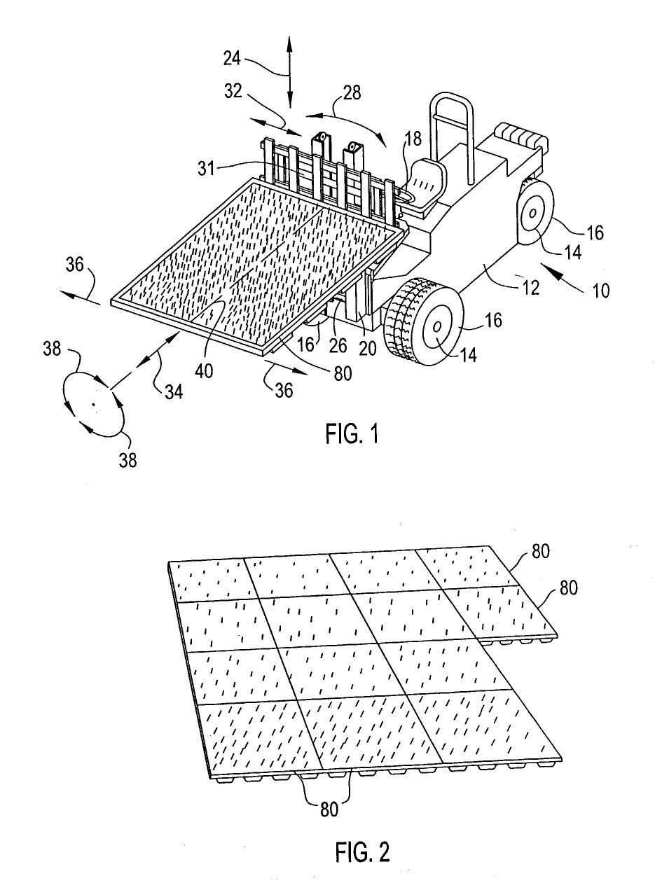

Referring now to FIG. 1, a tricycle forklift 10 in accordance with the present invention is shown. The forklift 10 includes a frame 12 mounted on three wheels 14. The wheels 14 have low pressure, preferably 12 psi, high flotation tires 16. An engine (not shown in FIG. 1) is mounted to the frame to drive the front wheels, and the rear wheel 14 is pivotally mounted and connected to the steering wheel 18 in a known manner.

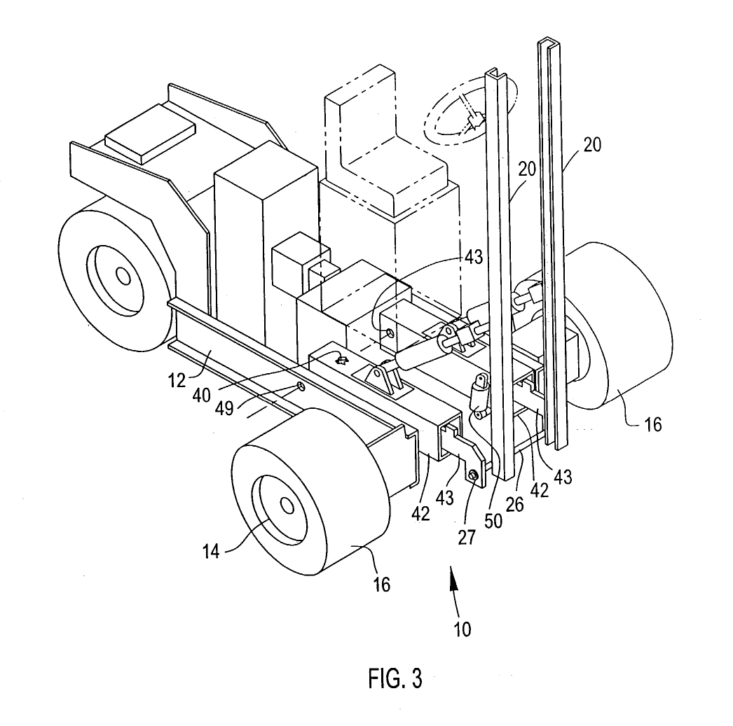

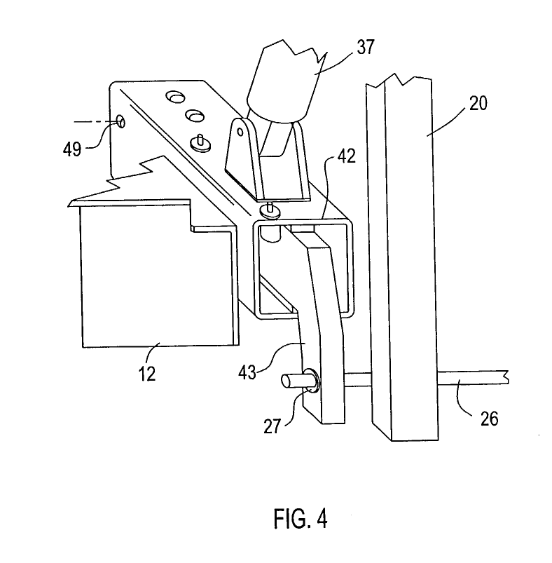

The forklift 10 includes a mast assembly 20, for raising and lowering the fork assembly 22 in the known manner, as indicated by arrow 24. The mast assembly 20 is preferably pivotally attached at its base by a pin 26 in order to allow the mast assembly 20 to be tilted forward and backward, as indicated by arrow 28. The tilting is preferably done via a hydraulic actuator 37, connected to the mast assembly 20 above the pin 26, as shown in FIG. 3.

The mast assembly 20 is preferably connected to the frame 12 by a mast support assembly that includes hydraulic actuators to allow additional degrees of freedom for movement of the fork assembly 22 and mast assembly 20 and, for example, the turf tray 80 shown as being carried thereon. Preferably, the fork assembly, 22 is also mounted to the mast assembly 20 with at least one linear actuator 31 that allows the fork assembly 22 to shift sideways relative to the mast assembly 20, as indicated by arrow 32. This allows exact side-to-side placement of a tray 80 against a neighboring tray 80 without having to move the entire vehicle 10 on its wheels 14. While a linear actuator is preferred, other types of actuators, such as a gear and motor drive could be used.

At least one, and preferably two front-to-back oriented linear actuators 40 are also connected between the mast assembly 20 and the frame 12, which allows for precise forward and backward movement of the mast assembly 20 and fork assembly 22 relative to the frame 12, as indicated by arrow 34, without the need for moving the entire forklift 10. The actuators 40 are preferably mounted in tubes 42, which have actuator arms 43 extending from a front end thereof to which the bottom of the mast assembly 20 is pivotably connected to via a pin 26. This allows for precise forward positioning of the trays 80, which is critical for providing a seamless surface appearance, and also avoids damage to the trays 80 being pushed together by movement of the entire forklift 10, since the drive of the wheels 14 can not be that precisely controlled.

The mast assembly 20 is also mounted to allow for yaw movement, of preferably at least 5°, as indicated by arrows 36, as well as side-to-side tilting of at least preferably 5°, as indicated by arrows 38, about a central axis 40. The tubes 42 are preferably pivotably mounted at their back ends with horizontally extending pins 49 to allow movement of the tubes 42 in an X-Z plane. Hydraulic actuators 50 are then connected to the tubes 42 at the front end and can be individually controlled to separately pivot the tubes 42 up and down. These are connected with appropriate bearings and pivot shafts or pins. Other types of actuators and pivoting or articulated joints can also be utilized.

In order to cause a side-to-side tilt of the mast assembly 20/fork assembly 22, one tube 42 is raised while the other remains stationary or is lowered. In order to yaw the mast 20/fork assembly 22, only one of the actuators 40 is activated to extend one of the actuator arms 43 while the other remains stationary or is moved in the opposite direction. Appropriate pivoting bearings 27 are provided in the base of the mast 20 through which the pin 26 is inserted.

In use, the forklift 10 can place trays 80 in a grow-in area, where turf is grown in the trays 80. The trays 80 can be precisely located and butted together, as shown in FIG. 2 to provide a continuous surface. Once the turf is grown in, the forklift 10 is used to move the trays to transport vehicles for transport to an installation job site, such as an athletic field. The turf trays 80 can then be precisely positioned to form the athletic field with only minimal surface dressing being required after placement to ensure that the seams between the trays 80 are not evident.

The low ground pressure, high flotation tires 14 prevent damage to the turf if the forklift 10 is driven over installed turf.

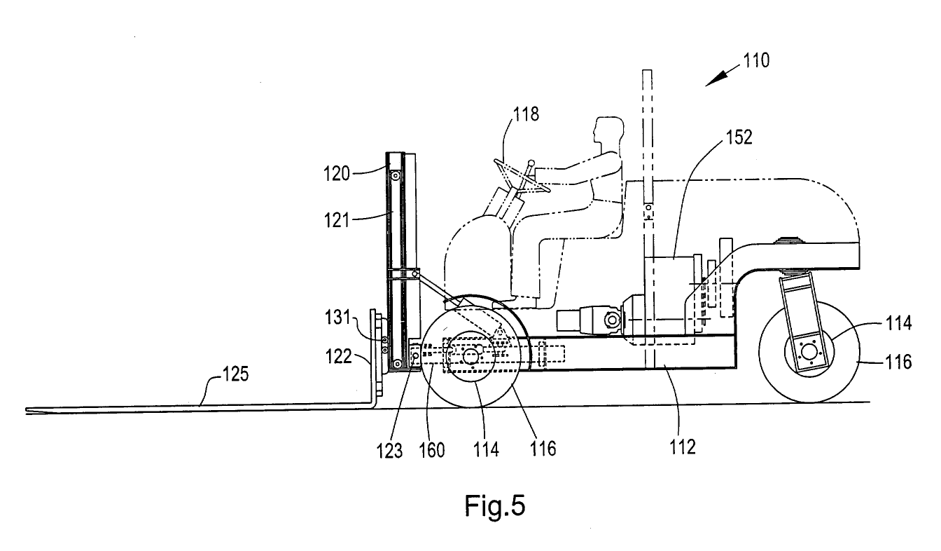

Referring now to FIGS. 5-12, a second embodiment of a forklift 110 in accordance with the present invention is shown. As shown in FIG. 5, the forklift 110 is similar to the forklift 10 in accordance with the first preferred embodiment of the invention and includes a frame 112 having three wheels 114 with high-flotation tires 116 thereon. An engine 152 is mounted on the frame 112 to provide power to drive the front wheels and the actuators. A rear wheel 114 is pivotally mounted to the frame. Preferably, the rear wheel 114 is controlled by a steering wheel 118 and is steered via a hydraulic or other type of actuator in response to the steering wheel movements.

A mast assembly 120 is mounted at the front of the forklift 110 via a mast support assembly 160. A fork assembly 122 is mounted to the mast assembly 120. The mast assembly 120 preferably includes two generally vertically oriented hydraulic actuators 121 for moving the fork assembly 122 up and down. The mast assembly 120 is preferably also pivotally connected to the mast support assembly 160 at by a pivot connection 123 to allow fore and aft pivoting of the mast assembly about a horizontal axis extending generally transversely to a longitudinal axis of the forklift 110. The fork assembly 122 is connected to the mast assembly 120 to allow for side-to-side sliding movement of the fork assembly 122 via an actuator 131 for a side-to-side positioning of objects. Preferably, the actuator 131 is a hydraulic actuator. However, other types of actuators can be utilized.

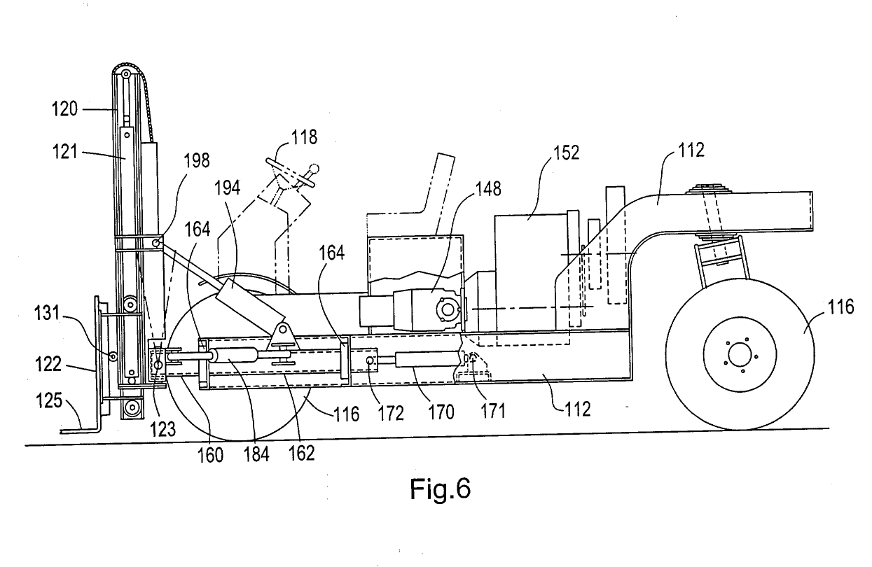

Referring now to FIGS. 6-9, the mast support assembly 160 is shown in detail. The mast support assembly 160 includes a movable fore and aft extending beam 162. The beam 162 is supported for sliding movement in two spaced apart supports 164. As shown in detail in FIGS. 8-10, each support 164 has an opening 166 defined therethrough having a complementary shape to a cross-section of the beam 162. The supports 164 are mounted for rotation in a plane transverse to a longitudinal axis of the beam 162. The supports 164 are generally circular and are preferably made of a high-density polyethylene or UHMWPE and are mounted for rotation in generally circular-shaped holders 168 that are connected to cross members of the frame 112.

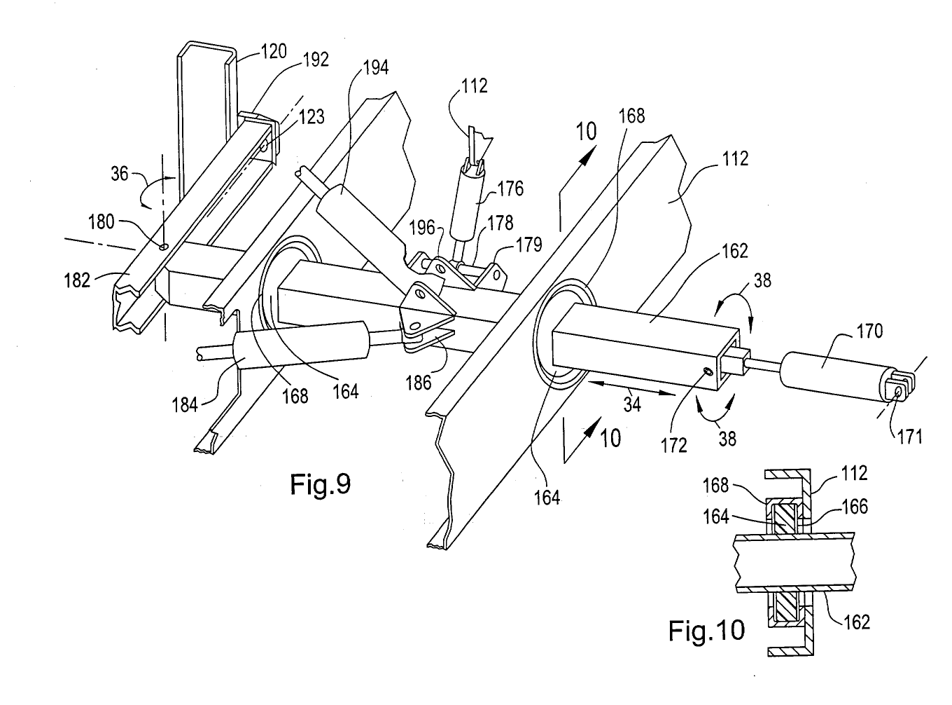

As shown in detail in FIGS. 6 and 9, a fore/aft movement actuator 170 is connected between the beam 162 and the frame 112 for generating forward and backward movement of the fork assembly 122. Preferably, pivot connections 171, 172 are provided at each end of the actuator 170. Additionally, the actuator rod is rotatable within the actuator housing in order to allow rotation of the beam 162, as described in further detail below.

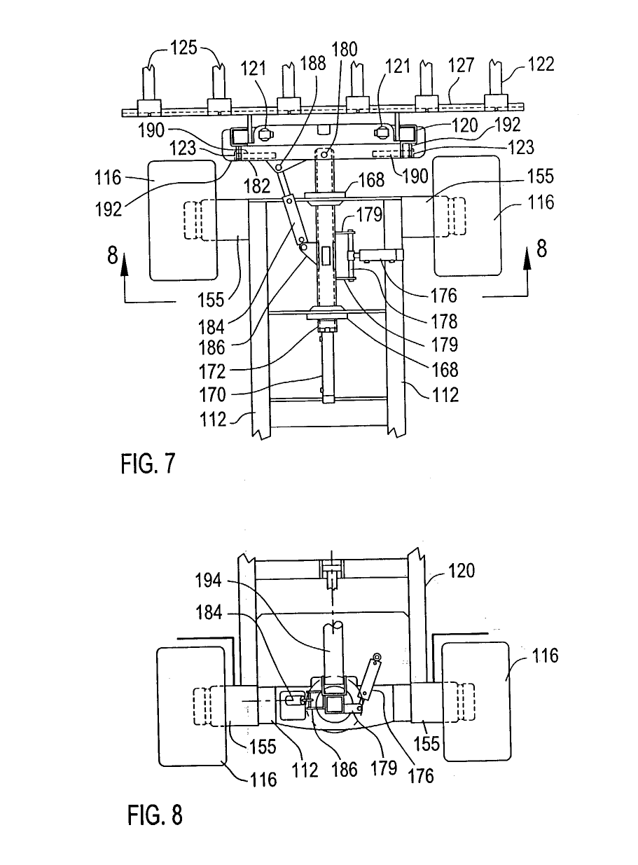

Referring now to FIGS. 7-9, a rotation actuator 176 is connected between the frame 112 and the beam 162 for rotating the beam about a longitudinal axis thereof to generate a side-to-side tilting of the fork assembly 122. The rotation actuator 176 is preferably pivotally connected to the frame 112 at a first end and connected to the beam 162 at a second end thereof in a manner which allows the beam 162 to slide fore and aft based upon movement of the fore/aft actuator 170 while still allowing the rotation actuator 176 to rotate the beam 162. Preferably, the second end of the rotation actuator 176 is attached to a round bar 178 mounted parallel to the longitudinal axis of the beam 162 on brackets 179, as shown in FIGS. 7-9. As the beam 162 is moved fore and/or aft by the fore/aft actuator 170, the beam 162 slides in the openings of the supports 164. For side-to-side tilting movement, the rotation actuator 176 is actuated in order to rotate the beam 162 which is carried in the supports 164 which rotate in the support holders 168. The connection between the rotation actuator 176 and the beam 162 is maintained by allowing the second end of the rotation actuator 176 to slide along the rod 178, which is oriented parallel to the longitudinal axis of the beam 162. Accordingly, fore/aft movement of the beam 162 and rotation are independently controllable.

Referring now to FIGS. 7 and 9, a generally vertically extending pivot connection 180 is located between the front end of beam 162 and a mast support bar 182. A yaw actuator 184 is connected between the beam 162 and the mast support bar 182. A first end of the yaw actuator 184 is preferably pivotably connected to a clevis arrangement 186 located on the beam 162. The second end of the yaw actuator 184 is pivotally connected by a second pivoting connection 188 to the mast support bar 182. As shown in FIGS. 8 and 9, a clearance opening may be provided through the frame cross member, if required, in order to allow the yaw actuator 184 to be connected between the beam 162 and the mast support bar 182. The yaw actuator 184 moves with the beam 162 upon actuation of the fore/aft movement actuator 170 so that a yaw of the mast assembly 120 remains unchanged and can be controlled mutually exclusively from the fore/aft movement and side-to-side tilting of the mast assembly 120.

Referring now to FIGS. 7 and 9, the pivot connection 123 between the mast support bar 182 and the mast assembly 120 is shown in detail. The pivoting connection 123 is formed by pins 190 that extend through openings in connector plates 192 attached to the mast assembly 120 and openings in the ends of the mast support bar 182. A fore/aft tilt actuator 194, shown in detail in FIGS. 6 and 9, is connected between the beam 162 and the mast assembly 120. Preferably, a pivot connection 196 is provided at the first end of the actuator 194, with a clevis connected to the beam 162 and a pivoting connection 198 is provided at the second end at a point on the mast assembly 120 located above the pivot connection 123. By connecting the first end of the fore/aft tilt actuator 194 to the beam 162, tilting movement of the mast assembly 120 can be controlled independently and exclusively of fore/aft movement, side-to-side tilting and yaw.

Preferably, all of the actuators are hydraulic actuators and a hydraulic pump 154 is connected to the frame and driven by the motor 152. Appropriate hydraulic lines and a hydraulic controls are provided for each actuator. Additionally, preferably the front wheels 114 of the forklift 110 are driven via hydraulic motors 155 located at each wheel. While linear actuators are preferred, it would also be possible to utilize a rotary actuator with a gear and/or toothed belt drive for rotation of the beam 162. It would also be possible to use other types of actuators, such as electric motor driven jackscrew type actuators to control the movements of the mast assembly 120 as well as the fork assembly 122.

As shown in FIGS. 6 and 7, the fork assembly 122 preferably includes a plurality of forks 125 that can be movably positioned along a support frame 127. The forks are generally L-shaped and are of the type generally known to those skilled in the art. Upward and downward movement of the fork assembly 122 is accomplished via the actuators 121 extending upwardly or downwardly and lifting the fork assembly along the generally vertically extending channels of the mast assembly 120 by pressing upwardly on a flexible chain that extends between a fixed point on the back of the mast assembly 120, over the tops of the actuators 121 and down to the fork assembly 122. This type of arrangement is generally known to those skilled in the art and accordingly will not be described in further detail herein. The side-to-side movement of the fork assembly 122, which is accomplished by the actuator 131, is also generally known to those skilled in the art and accordingly, a further description is not necessary herein.

Based on the mounting of the mast assembly 120 to the mast support assembly 160, the movements controlled by the actuators 121 and 131 can also be carried out independent and exclusive of side-to-side tilting, fore/aft movement and yaw.

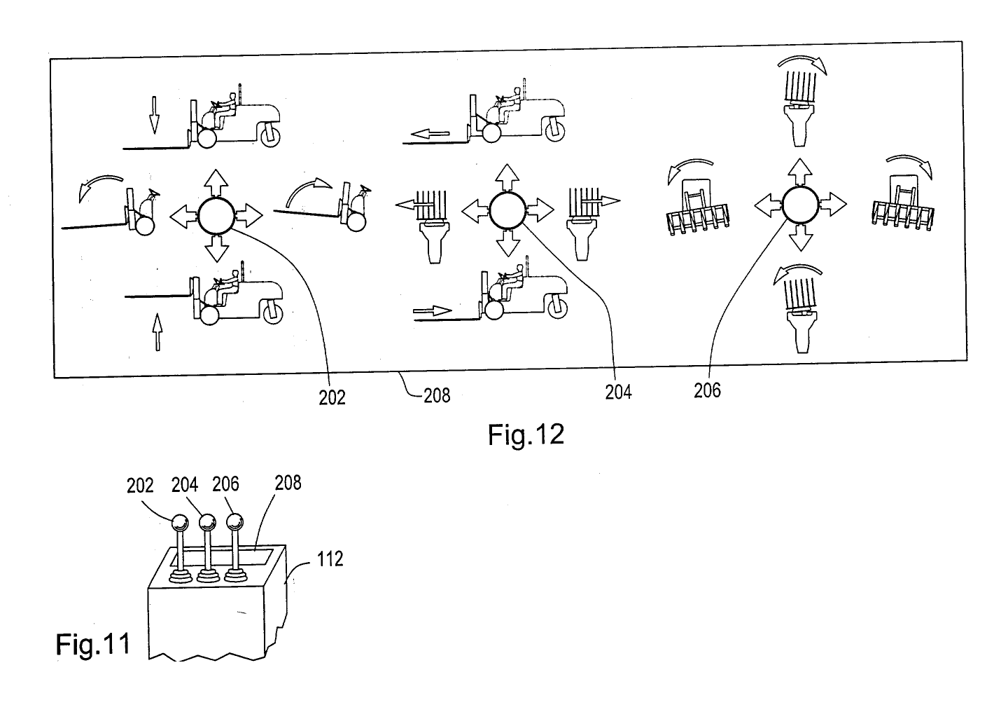

As shown in FIG. 6, preferably a joystick control arrangement is provided for the forklift operator. As shown in FIG. 11, preferably three joysticks 202, 204, 206 are provided. Each joystick 202, 204, 206 can be moved fore and aft or side to side to control two separate functions. Preferably, a legend 208 is provided on the frame structure 112 adjacent to the joysticks 202, 204, 206 to show an operator the control functions. As shown in FIGS. 11 and 12, preferably the joystick 202 controls up/down movement of the fork assembly 122 when it is moved forward and aft. Side-to-side movement of the joystick 202 controls the front to back tilting of the mast assembly 120 and fork assembly 122. The second joystick 204 preferably controls fore and aft extending of the beam 162 when it is moved in a fore and aft direction. Side-to-side movement of the second joystick 204 controls side-to-side shifting of the fork assembly 122 relative to the mast assembly 120.

Fore and aft movement of the third joystick 206 preferably controls yaw movement of the fork assembly 122 and mast assembly 120. Side-to-side movement of the third joystick 206 controls side-to-side tilting of the fork assembly 122 and the mast assembly 120 by rotation of the beam 162.

Each joystick is preferably connected to a hydraulic control valve which supplies or cuts off a pressurized supply of hydraulic fluid to the respective actuators.

With the arrangement provided by the forklift 110 in accordance with the second preferred embodiment of the invention, each of the movements of the fork assembly 122 can be mutually, exclusively and independently adjusted in an extremely fine manner to allow precise placement of items, such as trays of natural or synthetic turf. This is critical for assembly of sports fields since seams between adjacent trays 80 can cause injury to athletes and are therefore unacceptable. Additionally, this precise movement can be carried out without moving the forklift 110 itself, which prevents overshifting of the item, which can cause damage to the adjacent trays that have been placed. While the forklift 110 in accordance with the present invention is preferred for placement of synthetic or natural grass turf tiles 80, it can be used in other applications where precise shifting and adjustment of an item being moved is required.

It will be appreciated by those skilled in the art that changes can be made to the embodiments described above without departing from the broad inventive concept thereof. It is understood, therefore, that this invention is not limited to the particular embodiment disclosed, but is intended to cover modifications within the spirit and scope of the present invention.

What is claimed is:

1. A forklift for placing turf trays, comprising:
a frame mounted on low ground pressure, high flotation tires;
a mast assembly connected to the frame, with a fork assembly connected thereto, the mast assembly being connected to the frame by a mast support assembly that allows forward and backward movement of the fork assembly, side-to-side tilting of the fork assembly, and yawing of the fork assembly relative to the frame.

2. The forklift of claim 1, wherein the fork assembly is moveable up and down on the mast assembly, and the mast assembly includes a mast that is tiltable fore and aft.

3. The forklift of claim 2, wherein the fork assembly includes forks mounted for side-to-side movement.

4. The forklift of claim 1, wherein the mast support assembly includes two tubes, each mounted to the frame at a first end for pivoting movement in a generally vertical, fore and aft extending plane, and a first actuator mounted in each of the tubes extending from a second end thereof, the first actuators being pivotably connected to the mast assembly, and a second set of actuators that act on the tubes such that the second end of each of the tubes is moveable up and down.

5. The forklift of claim 1, wherein the mast support assembly includes a moveable, fore and aft extending beam mounted for fore and aft movement and rotary movement about a longitudinal axis thereof, a rotation actuator being connected between the frame and the beam for generating the side-to-side tilting of the fork assembly, and a fore/aft movement actuator being connected between the beam and the frame for generating the forward and backward movement of the fork assembly.

6. The forklift of claim 5, wherein a generally vertically extending pivot connection is located between a font end of the beam and a mast support bar, and a yaw actuator is connected between the beam and the mast support bar, the yaw actuator moving with the beam upon actuation of the fore/aft movement actuator, so that a yaw of the mast assembly remains unchanged.

7. The forklift of claim 6, wherein the mast assembly is pivotably connected to the mast support bar by a pivot joint having an axis that extends generally transverse to an axis of the moveable beam, and a fore/aft tilt actuator is connected between the mast assembly and the moveable beam, the fore/aft tilt actuator moving with the beam upon actuation of the fore/aft movement actuator such that a fore/aft tilt of the mast assembly remains unchanged.

8. The forklift of claim 6, wherein the fore/aft actuator, the rotation actuator and the yaw actuator are hydraulic actuators, and a hydraulic pump is mounted on the frame to supply hydraulic fluid to the actuators.

9. The forklift of claim 5, wherein the rotation actuator is slidably connected to the moveable beam such that a side-to-side tilt of the beam remains unchanged upon actuation of the ore/aft actuator.

10. The forklift of claim 5, wherein the side-to-side tilting, the forward and backward movement and the yaw can be mutually exclusively and independently adjusted.

11. The forklift of claim 5, wherein the moveable beam is supported for sliding movement in two spaced apart supports, each having an opening defined therethrough having a complementary shape to a cross-section of the beam, the supports each being mounted for rotation in a plane transverse to a longitudinal axis of the beam.

12. The forklift of claim 11, wherein the supports are generally circular and are made of a high density polyethylene, and the moveable beam slides in the openings in the supports.

13. The forklift of claim 1, wherein the front wheels are independently powered by a hydraulic motor located at each of the front wheels.

14. The forklift of claim 1, wherein movement of the fork assembly is controlled by three joy sticks, each controlling two movements of the fork assembly.
